(19) United States
(12) Patent Application Publication
(10) Pub. No.: US 2007/0278456 A1
(43) Pub. Date: Dec. 6, 2007

(54) SOLDER PASTE

(75) Inventors: Tadahiko Sakai, Fukuoka (JP); Tadashi Maeda, Fukuoka (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/754,421

(22) Filed: May 29, 2007

(30) Foreign Application Priority Data
May 30, 2006 (JP) 2006-149200

(51) Int. Cl. H01B 1/22

(52) U.S. Cl. 252/512

(57) ABSTRACT

In a solder paste 3 formed by allowing a resin component 3a having oxide removability to contain solder particles 4A, 4B, and 4C which are formed by coating the surfaces of core particles 6A, 6B, and 6C made of tin (Sn) or an alloy of tin with silver (Ag) coating films 7A, 7B, and 7C, the core particles are distributed to have such a particle distribution that the average particle diameter is in the range of 3 μm to 7 μm and 75% or more of the particles is in the range of 1 μm to 9 μm and the coating film is formed so that the core particles are coated with a silver coating film of an amount which occupies 1 to 4 wt % of the solder particles. Accordingly, it is possible to prevent oxide from being formed on the surfaces of the solder particles and to enhance the solder wettability at the time of soldering. In addition, it is possible to secure printability onto fine electrodes and to secure excellent solder adhesion with respect to a fine-pitch part by the use of a simple and low-cost method.

### BACKGROUND OF THE INVENTION

The present invention relates to a solder paste used to solder an electronic part onto a substrate.

A surface mounting method using a solder paste, which is formed by allowing a resin component to contain solder particles to form a paste, as a soldering material is known as a method of mounting electronic parts on a substrate. In the method, the solder can be supplied onto adhesion target portions at a time by forming the solder paste on the substrate using a screen printing method and a plurality of parts can be soldered onto the substrate at a time by heating the substrate by the use of a reflow apparatus after mounting the parts on the substrate. Accordingly, a simple and low-cost mounting method can be embodied.

Solder pastes using solder particles having a structure in which the surfaces of the solder particles as cores are coated with a passivation film of a different kind of metal have been suggested as the solder paste for soldering the electronic parts (see Patent Documents 1 to 5). The purposes thereof are all to secure solder wettability at the time of reflowing and to enhance an adhesion property by coating solder components, which are melted to form soldering portions, with coating films of metal such as silver which is hardly oxidized by means of exposure to the atmospheric air. So-called lead-free solder particles not containing a lead component in an alloy are used in Patent Documents 2 to 5).

[Patent Document 1] Japanese Unexamined Patent Publication No. 5-154687

[Patent Document 2] Japanese Unexamined Patent Publication No. 8-164496

[Patent Document 3] Japanese Unexamined Patent Publication No. 2001-321983

[Patent Document 4] Japanese Unexamined Patent Publication No. 2002-120086

[Patent Document 5] Japanese Unexamined Patent Publication No. 2002-331385

With a recent decrease in size of electronic apparatuses, pitches of electrodes for bonding electronic parts to a substrate becomes finer and it is required that terminals of parts are soldered to fine electrodes formed with a small pitch of 100 μm or less. However, in the solder pastes described in the above-mentioned patent documents, since the particles diameters of the contained solder particles are 10 μm or more, it is not possible to stably print the solder paste on fine electrodes.

In order to enhance the printability to the fine electrodes, the decrease in particle diameter of the solder particles contained in the solder paste is required. However, the decrease in particle diameter of the solder particles in the solder paste causes the following problems and thus fine solder pastes of 10 μm or less cannot be used for the solder paste.

The decrease in size of the solder particles greatly increases the surface area per weight of the solder paste. As a result, the amount of oxide existing on the surfaces of the solder particles increases and thus the merging of the solder particles in the course of soldering tends to be hindered. The oxide can be removed by adding an activator having a strong activation. However, when the ratio of the activator increases, electrodes or wiring circuits are corroded by the remaining active components after the soldering, thereby deteriorating the reliability. Accordingly, it is difficult to solve the problem with oxide by using only the activator.

It was found out that the solder particles having a configuration in which the surfaces are coated with a coating film are simply scaled down to 10 μm or less as shown in the patent documents, the wettability is contrarily deteriorated against the purpose of enhancement in wettability by preventing the generation of oxide by the use of the coating film. That is, the surface area per weight of the solder particles increases as described above when the size of the solder particle decreases and the ratio of the metal component in the coating film to the metal of the core particles relatively increases. As a result, the melting point of the alloy formed due to the diffusion of the coating film into the core particles increases, thereby causing a phenomenon that the wettability is deteriorated.

In other words, when fine solder particles having a size smaller than 10 μm are used in the solder paste, the wettability is necessarily improved only by forming an anti-oxidation coating film to reduce the influence of the oxide. In this way, the conventional solder paste makes it difficult to secure an excellent solder adhesion property with respect to fine-pitch parts, on which fine electrodes are formed with a small pitch, by the use of a simple and low-cost method.

### SUMMARY OF THE INVENTION

Accordingly, it is an object of the invention to provide a solder paste which can secure an excellent solder adhesion property with respect to a fine-pitch part by the use of a simple and low-cost method.

According to an aspect of the invention, there is provided a solder paste formed by allowing a resin component having oxide film remove function to contain solder particles in which surfaces of core particles are coated with a coating film, wherein the core particles are obtained by shaping a first metal into spherical particles and distributing the spherical particles with a particle diameter distribution in which the average particle diameter is in the range of 3 μm to 7 μm and at least 75% of the particles is in the range of 1 μm to 9 μm, and wherein the coating film is made of a second metal having a melting point higher than that of the first metal, hardly generating a natural oxide film, and being capable of forming an alloy along with the first metal, and the amount of the coating film relative to the entire solder particles is set to a range in which the melting point of the alloy formed by the first metal and the second metal is lower than the melting point of the first metal.

According to another aspect of the invention, there is provided a solder paste formed by allowing a resin component having oxide remove function to contain solder particles in which surfaces of core particles are coated with a coating film, wherein the core particles are obtained by shaping tin (Sn) or an alloy containing tin as a primary component but not containing lead (Pb) into spherical particles and distributing the spherical particles with a particle diameter distribution in which the average particle diameter is in the range of 3 μm to 7 μm and at least 75% of the particles is in the range of 1 μm to 9 μm, and wherein the coating film is formed by coating the surfaces of the core particles with a silver (Ag) film of an amount which occupies 1 to 4 wt % of the solder particles.

According to the invention, by coating the surfaces of the core particles with the second metal which has a melting point higher than that of the first metal, which hardly generates a natural oxide film, and which is capable of forming an alloy along with the first metal and setting the amount of the coating film relative to the entire solder particles to the range in which the melting point of the alloy formed by the first metal and the second metal is lower than the melting point of the first metal, specifically by using the solder particles formed by shaping tin (Sn) or an alloy containing tin as a primary component but not containing lead (Pb) into spherical particles and coating the surfaces of the core particles of fine particle diameters, which has a particle diameter distribution in which the average particle diameter is in the range of 3 μm to 7 μm and at least 75% of the particles is in the range of 1 μm to 9 μm, with a silver (Ag) film of an amount which occupies 1 to 4 wt % of the entire solder particles, it is possible to prevent oxide from being formed on the surfaces of the solder particles and to enhance the solder wettability at the time of soldering. In addition, it is possible to secure printability onto fine electrodes and to secure excellent solder adhesion with respect to a fine-pitch part by the use of a simple and low-cost method.

### BRIEF DESCRIPTION OF THE DRAWINGS

FIGS. 1(a) to 1(c) are perspective views of a substrate on which burns are formed out of a solder paste according to an embodiment of the invention;

FIG. 2(a) is a diagram illustrating a configuration of solder particles in the solder paste according to an embodiment of the invention;

FIG. 2(b) is a graph illustrating a particle diameter distribution of the solder particles in the solder paste according to the embodiment of the invention;

FIG. 3 is a phase equilibrium diagram of an Sn—Ag alloy forming solder particles of the solder paste according to an embodiment of the invention;

FIGS. 4(a) to 4(d) are cross-sectional views illustrating processes of a method of forming a bump out of a solder paste according to an embodiment of the invention;

FIGS. 5(a) to 5(c) are diagrams illustrating a behavior of solder particles in a soldering process using a solder paste according to an embodiment of the invention; and

FIGS. 6(a) to 6(c) are diagrams illustrating processes of a method of mounting an electronic part by the use of a solder paste according to an embodiment of the invention.

### DETAILED DESCRIPTION OF THE PREFERRED EMBODIMENTS

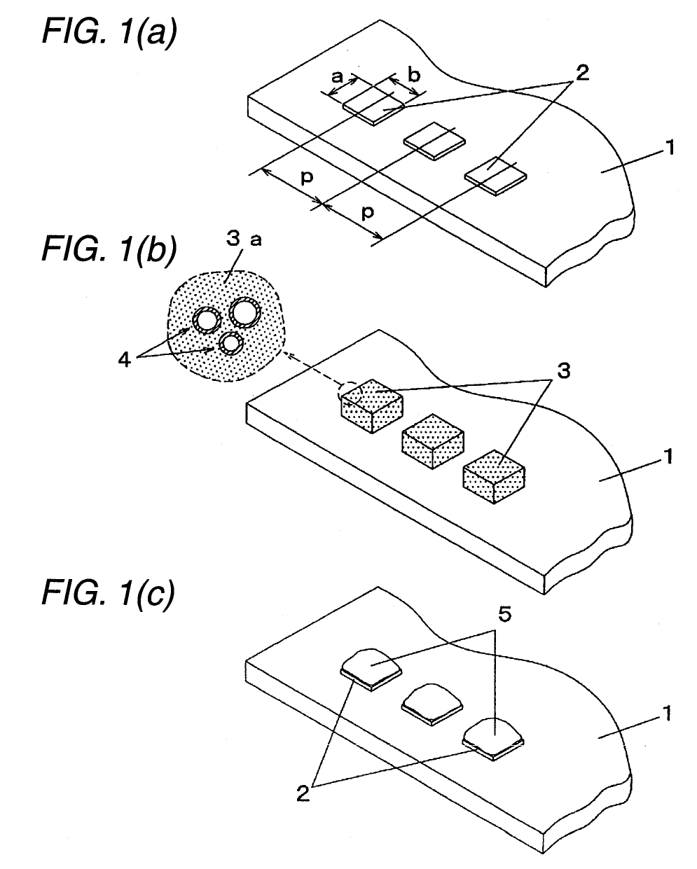

Hereinafter, an embodiment of the invention will be described with reference to the drawings. First, a substrate on which part connecting bumps are formed out of a solder paste according to an embodiment of the invention will be described with reference to FIG. 1. In FIG. 1(a), part connection electrodes 2 are formed on a substrate 1. The substrate 1 is a substrate with a high mounting density on which fin-pitch parts are mounted. The electrodes 2 have a narrow inter-electrode pitch p smaller than 100 μm and the two-dimensional sizes of the electrodes 2 are all several tens μm.

At the time of mounting electronic parts on the substrate 1, as shown in FIG. 1(b), first, a solder paste having a structure in which solder particles 4 are contained in a resin component 3a having oxide removability is supplied to the electrodes 2. Subsequently, by heating the substrate 1 as a whole, the solder particles 4 in the solder paste 3 are melted and fixed to the electrodes 2, as shown in FIG. 1(c), to form solder bumps 5 on the electrodes 2. At the time of mounting an electronic part on the substrate 1, connection terminals of the electronic part 5 as a mounting object and the electrodes 2 are soldered to each other using the solder bumps 5.

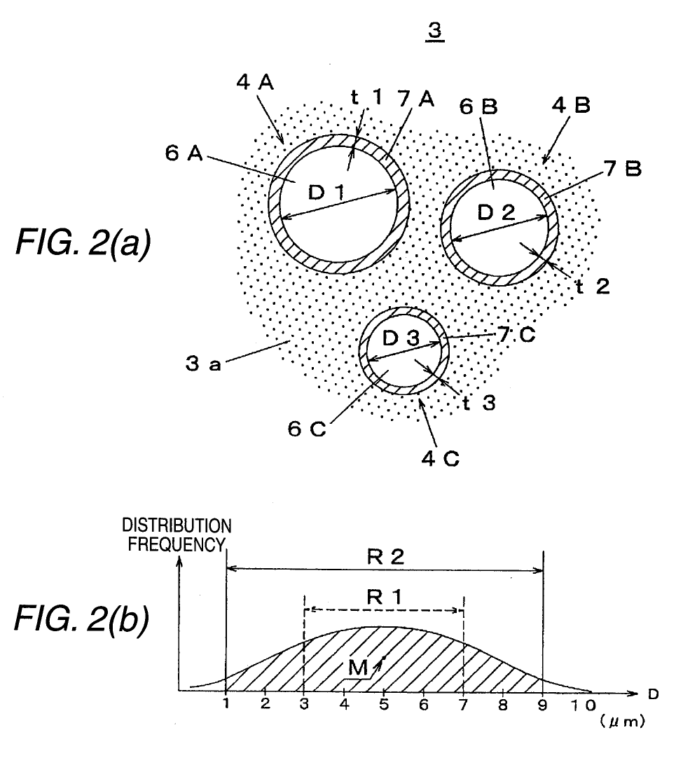

A structure of the solder paste 3 is described with reference to FIG. 2. As shown in FIG. 2, the solder paste 3 has a structure in which a plurality of solder particles 4 such as solder particles 4A, 4B, 4C, . . . having different sizes are contained in the resin component 3a. A thermosetting resin to which an activator is added to apply oxide removability is used as the resin component 3a. A resin in which a hardener and an activator such as rosin are mixed into an epoxy resin as a primary agent is used as the thermosetting resin. Accordingly, it is possible to remove the oxide film formed on the surfaces of the electrodes 2 as a soldering object due to exposure to the atmospheric air. A rosin flux usually used for soldering may be used as the resin component 3a.

In the solder particles 4A, 4B, 4C, . . . , coating films 7A, 7B, 7C, . . . with different thicknesses t1, t2, t3, . . . , respectively, are formed on the surfaces of core particles 6A, 6B, 6C, . . . with different diameters D1, D2, D3, . . . . In the following description, the solder particles 4A, 4B, 4C, . . . , the core particles 6A, 6B, 6C, . . . , and the coating films 7A, 7B, 7C, . . . are represented by the solder particles 4, the core particles 6, and the coating films 7.

Here, the core particles 6 are formed of a first metal, that is, tin (Sn) or an alloy containing tin as a primary component, having a low melting point. An alloy obtained by adding one or more of bismuth (Bi), silver (Ag), and copper (Cu) to tin is preferably used as the alloy. In this embodiment, an alloy containing copper less than 0.8 wt % is used. An alloy containing 1 wt % or more of lead (Pb) and zinc (Zn) is excluded in the embodiment. That is, the lead not preferable from the viewpoint of environmental protection is excluded to reduce the environmental load and zinc easily oxidized due to the exposure to the atmospheric air is excluded to prevent natural oxide films from being formed on the surfaces of the core particles 6 to the maximum.

Particles obtained by distributing the particles, which have a random particle diameter distribution and are obtained by shaping the alloy into spherical particles using an atomizing method, so as to satisfy the following particle diameter distribution are used as the core particles 6. As shown in FIG. 2(b), the core particles 6 are selected so as to have such a particle diameter distribution that the average value M of the particle diameters D1, D2, D3, . . . of the core particles 6 is in the range R1 of 3 μm to 7 μm. The core particles are selected so that 75% or more of all the core particles 6 is in the range R2 of 1 μm to 9 μm. That is, the core particles 6 can be obtained by shaping the first metal not containing lead (Pb) into spherical particles and distributing the spherical particles in the particle diameter distribution in which the average particle diameter is in the range of 3 μm to 7 μm and 75% or more (more preferably 90% or more) of all the core particles are in the range of 1 μm to 9 μm. Additionally, the maximum diameter of the core particle is set to be less than 15 μm, so that variation in amount of the solder paste 3 that is printed on the electrode 2 is decreased.

By using the core particles 6 having small particle diameters as the solder particles 4 mixed into the solder paste 3, when the electrodes 2 having a small electrode size are to be soldered, it is possible to supply the solder paste 3 onto the electrodes 2 with excellent printability. That is, as described in Patent Documents 1 to 5, the solder particles conventionally used in the solder paste have the minimum particle diameter of about 10 μm and most of them have a large particle diameter much larger than the minimum particle diameter. Accordingly, it was not possible to accomplish excellent printability onto the fine electrodes having a plane size below 100 μm described in this embodiment.

The coating films 7 are described next. The coating films 7 are formed for the purpose of preventing oxide from being formed on the surfaces of the core particles 6 due to the exposure to the atmospheric air or the heating between the time point when the core particles are shaped into particles shapes and the time point of the soldering. In the state where the core particles 6 are melted in the course of soldering, the coating films 7 cover the surfaces of the core particles 6 while maintaining a solid phase on the surfaces of the core particles 6, and diffuse into the melted core particles 6 to form new solder alloys.

Accordingly, a metal not melted at the heating temperature in the solder process of heating and melting the core particles 6, that is, a metal having a melting point higher than the melting point of the first metal (tin or alloy containing tin as a primary component), hardly forming the natural oxide, and forming an alloy with the first metal, is selected as the metal (second metal) for forming the coating films 7. In this embodiment, silver (Ag) is used as such a metal and the coating films 7 are formed by attaching silver to the surfaces of the core particles 6 by the use of an electroless reduction plating method.

In this case, by setting the amount of silver for forming the coating films 7 to an amount occupying 1 to 4 wt % of the solder particles 4, the coating films 7 having a thickness suitable for the above-mentioned purpose. That is, when the amount of silver is less than 1 wt %, it is difficult to secure the amount sufficient for completely covering the core particles 6 to prevent the oxidation thereof. When the amount of silver is larger than 4 wt %, the solder particles 4 are softened due to the existence of silver in tin (Sn) as the primary component, thereby deteriorating the bonding strength. Accordingly, it was confirmed that it is not preferable for the above-mentioned purpose.

By setting the amount of silver for forming the coating films 7 to the amount occupying 1 to 4 wt % of the solder particles having the above-mentioned particle diameter distribution, the coating films 7 having a thickness of 2 nm to 70 nm are formed on the surfaces of the core particles 6. By covering the core particles 6 with the coating films 7 having such a thickness, it was confirmed experimentally that it is possible to effectively prevent the formation of the natural oxide due to the exposure to the atmospheric air and the solder particles 4 are melted and merged with each other in the soldering process.

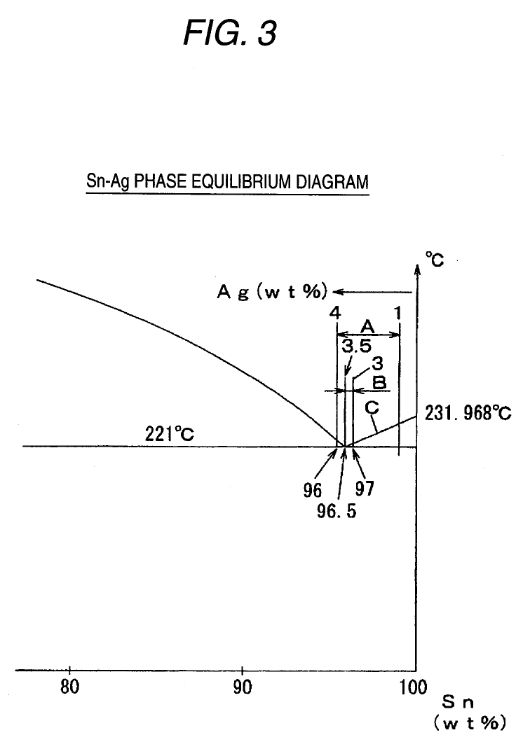

Now, the reason for setting the amount of silver for forming the coating films 7 to the range of 1 to 4 wt % is described with reference to the Sn—Ag phase equilibrium diagram of FIG. 3. As shown in FIG. 3, the Sn—Ag two-component eutectic point is Sn 96.5 wt % (Ag 3.5 wt %) and the lowest melting point 221° C. appears in the composition. That is, by previously setting the amount of silver of the coating films 7 to be close to the amount of silver in the eutectic state, the melting point of the alloy formed by diffusing the coating films 7 into the core particles 6 can be set to a temperature lower than the melting point (231.968° C.) of the metal (Sn 100 wt %) for forming the core particles 6 (see liquid phase line c shown in FIG. 3).

In this embodiment, when the mixture ratio of silver is set so that the amount of silver occupies 1 to 4 wt % (range A shown in FIG. 3) of all the solder particles 4, the melting point of the solder bump formed by melting and hardening the solder particles 4 can be set lower than the melting point of the core particles 6. That is, in this embodiment, the amount of the coating films 7 relative to the entire solder particles 4 is set to a range in which the melting point of the alloy containing the first metal for forming the core particles 6 and the second metal for forming the coating films 7 is lower than the melting point of the first metal. More preferably, by setting the mixture ratio of silver to 3 to 3.5 wt % (range B shown in FIG. 3), the composition is very close to the eutectic point of the Sn—Ag alloy and it is possible to secure the falling temperature (difference in eutectic point) from the melting point of the core particles 6 by 2° C. or more.

As described above, when an alloy in which copper of 0.8 wt % or less is added to tin is used as the first metal, the phase equilibrium diagram is a 3-component system. However, the 2-component system phase equilibrium diagram shown in FIG. 3 can be basically applied to this case. That is, when copper having the above-mentioned composition range exists, the melting point of the alloy formed of the first metal for forming the core particles 6 and the second metal for forming the coating films 7 is lower than the melting point of the first metal.

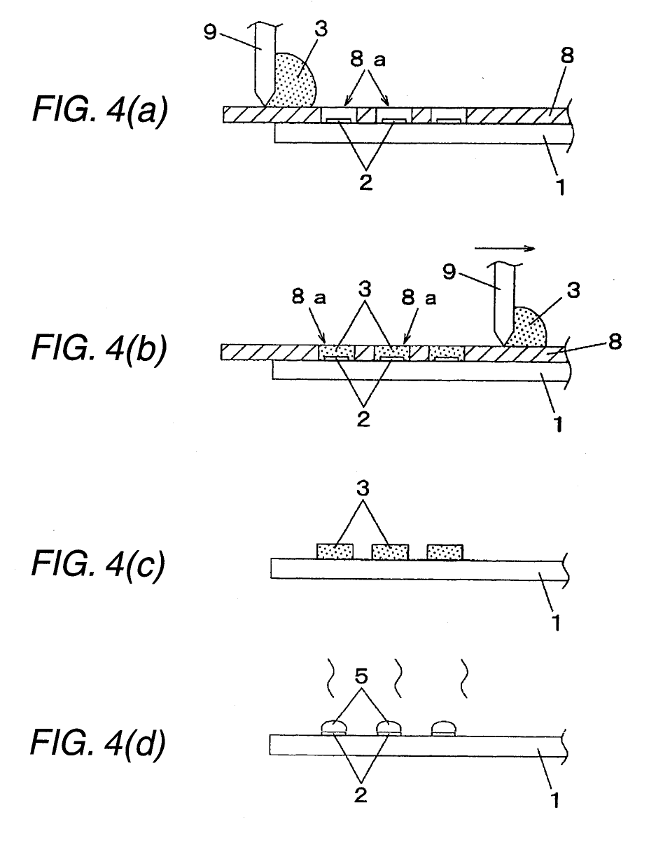

A solder bump forming method of forming the solder bumps 5 on the fine-pitch part mounting electrodes 2 formed on the substrate 1 shown in FIG. 1 by the use of the solder paste 3 described in this embodiment is described with reference to FIG. 4. First, the solder paste 3 is supplied to the top surface of the substrate 1 by the use of a screen printing method so as to cover the electrodes 2. In FIG. 4(a), a mask plate S is placed on the top surface of the substrate 1. Pattern holes 8a are formed in the top surface of the mask plate 8 so as to correspond to the electrodes 2. The solder paste 3 is supplied to the top surface of the mask plate 8 and the solder paste 3 is filled in the pattern holes 8a by allowing a squeegee 9 to slide along the top surface of the mask plate 8 as shown in FIG. 4(b). Thereafter, by separating the mask plate 8 from the substrate 1, a predetermined amount of solder paste 3 covering the electrodes 2 is supplied to the top surface of the substrate 1 as shown in FIG. 4(c).

Thereafter, by heating the substrate 1, on which the solder paste 3 is printed, in the reflow process, the solder particles 4 in the solder paste 3 is melted and attached to the electrodes 2 and thus the solder bumps 5 are formed on the electrodes 2. In a part mounting process of mounting an electronic part on the substrate 1, the connection terminals of the electronic part is soldered to the electrodes 2 with the solder bumps 5 interposed therebetween.

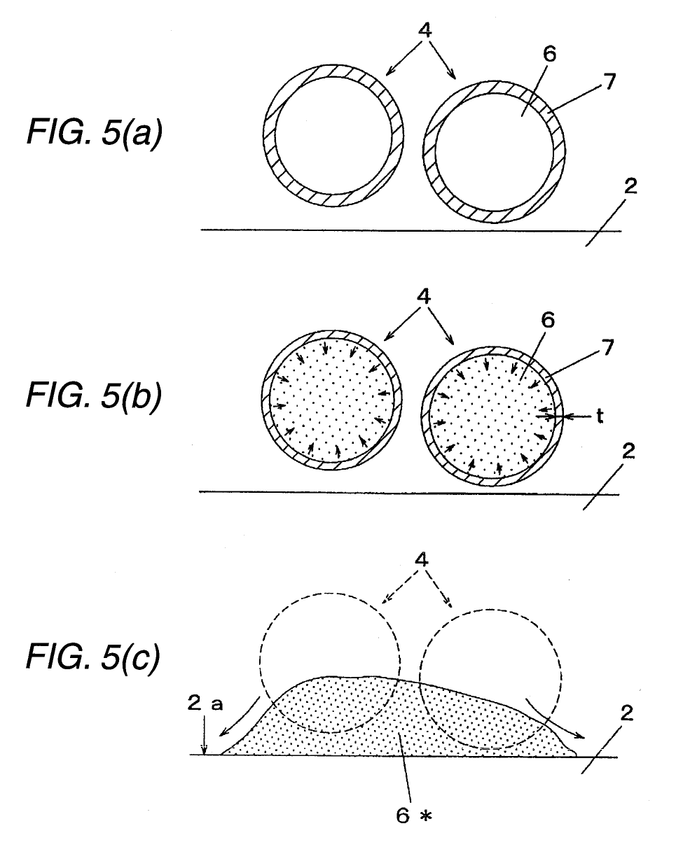

A melting behavior of the solder particles 4 in the solder paste 3 in the bump forming process is described with reference FIG. 5. FIG. 5(a) shows the solder particles 4 located in the vicinity of the surfaces of the electrodes 2 at the time of starting the heating in the reflow process. In the solder particles 4, the coating films 7 are formed on the surfaces of the core particles 6 with a thickness in which the amount of silver is in the above-mentioned range of ratio to tin or tin alloy for forming the core particles 6 is formed.

Thereafter, by starting the heating, the temperature of the solder paste 3 rises and reaches the melting point of tin or tin alloy for forming the core particles 6, thereby melting the core particles 6. Since the core particles 6 are melted, silver for forming the coating films 7 diffuse into the melted core particles 6 and the advancement of the diffusion decreases the thickness t of the coating films 7. At this time, since the heating temperature is lower than the melting point of silver constituting the coating films 7, the melted core particles 6 maintain the state where the surfaces of the coating films 6 are covered and the core particles 6 are protected from the oxidation due to the exposure to the atmospheric air and the heating. When the diffusion from the coating films 7 into the core particles 6 is further advanced and the solid-phase coating films 7 are almost lost, as shown in FIG. 5(c), the solder particles 4 cannot maintain the particle-shaped state any more and are melted. Accordingly, the neighboring solder particles are melted and merged with each other and the melted solder 6* in which the particles are melted and merged is diffused wet along the electrode surfaces 2a.

In the above-mentioned process, with the advancement of diffusion of silver from the coating films 7 into the core particles 6, the melted core particles 6 get close to the Sn—Ag eutectic solder composition and thus the melting point is lowered. That is, when the amount of silver is in the range of 3 to 3.5 wt % (range B shown in FIG. 3), the melting point is lowered up to the level very close to 221° C. which is the eutectic temperature. When the amount of silver departs from the range B but is in the range of 1 to 4 wt % (range A shown in FIG. 3), the melting point is lowered along the liquid phase line c shown in FIG. 3, depending on the degree of increase in amount of silver.

Due to the decrease in melting point, the melting point of the solder alloy formed by diffusing the coating films 7 into the core particles 6 is relatively lower than the ambient temperature which is reached by the heating of the reflow process. In other words, the state where the solder particles 4 are heated up to a temperature higher than the melting point of the melted solder is embodied in the electrodes 2 which is a bonding object of the solder particles 4. Accordingly, it is possible to obtain the same advantage as rapidly decreasing the surface tension of the melted solder and to secure excellent wettability at the time of diffusing the solder 6* shown in FIG. 5(c).

In the bump forming method using the solder paste 3 having the above-mentioned structure, since the solder bumps 5 are formed by the use of a very simple method of supplying the solder paste 3 to the substrate using the screen printing method and then melting and solidifying the solder component of the solder paste 8 on the electrodes using the reflow method, it is possible to form the solder bumps at very low cost, compared with the conventional method used as a method of supplying a solder paste to the electrodes of the same fine-pitch part substrate, for example, a method of forming a solder pre-coat on the electrodes using a metal substitution reaction (for example, super solder made by Harima Chemicals Inc.).

In the above-mentioned structure of the solder paste 3, the metal particles of which the particle diameters are in the range of 1 μm to 9 μm and which was disused without being used in the past, among the metal particles having random diameters manufactured by atomization, are mainly used. Accordingly, it is possible to cope with the request for effectively using resources. That is, the fine particle diameter particles were disused because the surface area per weight of the solder is large, the ratio of the oxide in the solder component is necessarily increased, and the merging between the solder particles is hindered due to the oxide in the soldering process, thereby making it difficult to perform a normal soldering process.

In the solder paste 3 described in this embodiment, by previously forming the coating films 7 in the fine core particles 6 not used due to the problem with oxide out of silver which hardly generates the oxide to form the solder particles 4, the ratio of oxide which is contained in the solder paste 3 is suppressed the lowest. As described above, by properly setting the amount of the coating films 7 relative to the entire solder particles 4, the melting point of the melted solder formed by diffusing the coating films 7 into the core particles 6 is lower than the melting point of the original core particles 6. Accordingly, in the course of heating and melting the solder paste 3 supplied to the electrodes 2, the wettability of the solder particles 4 in the solder paste 3 is improved and the solder particles 4 are melted and fixed to the surfaces of the electrodes 2 with an excellent soldering property without leaving the non-welded particles on the electrodes 2.

The activation component contained in the solder paste 3 is added by only the amount required for removing oxide from the surfaces of the electrodes 2 in the above-mentioned melting process. Accordingly, it is possible to reduce the problem due to the addition of a large amount of activation component, that is, the problem of corrosion or deterioration in insulating ability due to the remaining of the activation component in the soldering portion after forming the bumps or mounting the parts. In this way, by using the solder paste 3 described in this embodiment, it is possible to secure the excellent soldering property with respect to a fine-pitch part on which fine electrodes are formed with a small pitch.

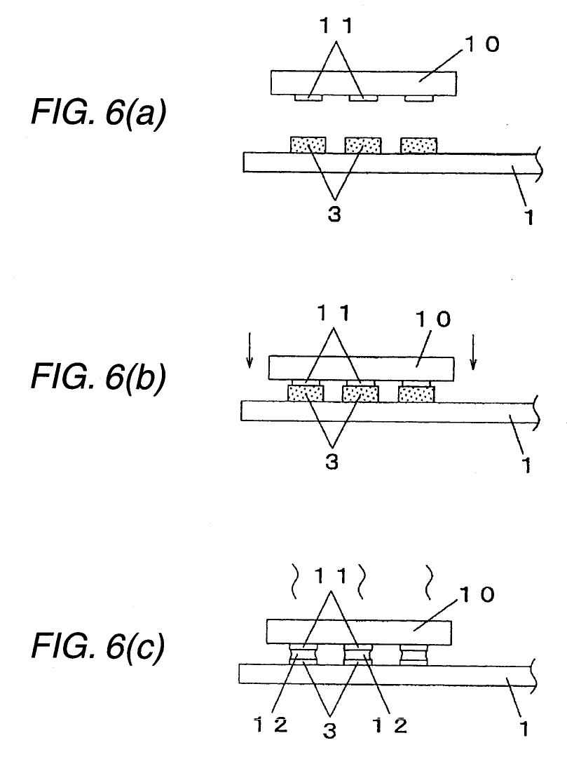

In the above-mentioned case, the example where the solder bump 5 is formed on the electrodes 2 using the solder paste 3 at the time of supplying the solder for mounting the electronic part to the substrate 1 has been described. However, as shown in FIG. 6, the solder paste 3 supplied to the electrodes 2 may be used for the soldering process of mounting the electronic part.

In FIG. 6(a), the substrate 1 is the same as the substrates 1 shown in FIGS. 1 and 4 and the solder paste 3 is supplied to the substrate 1 so as to cover the electrodes 2 by print in the same was as shown in FIG. 4. Subsequently, the electronic part 1 in which terminals 11 are formed on the bottom surface thereof is aligned with the substrate 1 and the electronic part 10 is directly placed on the substrate as shown in FIG. 6(b), thereby bringing the terminals 11 into contact with the solder paste 3. Thereafter, as shown in FIG. 6(c), the solder particles 4 in the solder paste 3 are melted by heating the substrate 1 along with the electronic part 10 by the reflow process, whereby soldering portions 12 for bonding the electrodes 2 to the terminals 11 by the use of the melted solder formed by melting the solder particles 4 are formed.

In this case, by using the same solder paste 3 as the above-mentioned example, it is possible to simply supply the substrate 1 with the solder and to enhance the wettability of the melted solder formed by melting the solder particles 4 in the course of soldering the terminals 11 and the electrodes 2 to each other, thereby securing the excellent soldering ability.

This application is based upon and claims the benefit of priority of Japanese Patent Application No. 2006-149200 filed on May 30, 2006, the contents of which are incorporated herein by reference in its entirety.

The solder paste according to the invention has an advantage which allows an excellent solder adhesion property with respect to a fine-pitch part by the use of a simple and low-cost method and can be used also for mounting fine-pitch parts on a substrate by a soldering process.

What is claimed is:

1. A solder paste comprising:
solder particles in which surfaces of core particles are coated with a coating film;
a resin component having oxide film remove function; and
wherein the core particles are obtained by shaping a first metal into spherical particles and distributing the spherical particles with a particle diameter distribution in which the average particle diameter is in the range of 3 μm to 7 μm, and at least 75% of the particles is in the range of 1 μm to 9 μm, and
wherein the coating film is made of a second metal having a melting point higher than that of the first metal, hardly generating a natural oxide film, and being capable of forming an alloy along with the first metal, and
the amount of the coating film relative to the entire solder particles is set to a range in which the melting point of the alloy formed by the first metal and the second metal is lower than the melting point of the first metal.

2. The solder paste according to claim 1, wherein maximum diameter of the core particle is set to be less than 15 μm.

3. The solder paste according to claim 1, wherein the first metal is one of tin and an alloy containing tin as a primary component and not containing lead (Pb) and the second metal is silver (Ag).

4. The solder paste according to claim 3, wherein the first metal contains 0.8 wt % or less of copper.

5. The solder paste according to claim 3, wherein the coating film is formed by plating the surfaces of the core particles with silver by the use of an electroless reduction plating method.

6. The solder paste according to claim 3, wherein the amount of silver is 1 to 4 wt % of the solder particles.

7. The solder paste according to claim 1, wherein the resin component is a thermosetting resin.

8. The solder paste according to claim 1, wherein the resin component is a soldering flux.

9. A solder paste comprising:
solder particles in which surfaces of core particles are coated with a coating film,
a resin component having oxide film remove function; and
wherein the core particles are obtained by shaping tin (Sn) or an alloy containing tin as a primary component but not containing lead (Pb) into spherical particles and distributing the spherical particles with a particle diameter distribution in which the average particle diameter is in the range of 3 μm to 7 μm and at least 75% of the particles is in the range of 1 μm to 9 μm, and
wherein the coating film is formed by coating the surfaces of the core particles with a silver (Ag) film of an amount which occupies 1 to 4 wt % of the solder particles.

10. The solder paste according to claim 9, wherein maximum diameter of the core particle is set to be less than 15 μm.

11. The solder paste according to claim 9, wherein the silver film is formed by plating the surfaces of the core particles with silver by the use of an electroless reduction plating method.

12. The solder paste according to claim 9, wherein the amount of silver occupies 1 to 4 wt % of the solder particles.

13. The solder paste according to claim 9, wherein the resin component is a thermosetting resin.

14. The solder paste according to claim 9, wherein the resin component is a soldering flux.
